(19) United States
(12) Patent Application Publication
(10) Pub. No.: US 2014/0244022 A1
(43) Pub. Date: Aug. 28, 2014

(54) DIGITAL CONTROL PROCESSING DEVICE

(71) Applicants: FIH (Hong Kong) Limited, Kowloon (HK); SHENZHEN FUTAIHONG PRECISION INDUSTRY CO., LTD., Shenzhen (CN)

(72) Inventors: JIE GAO, Shenzhen (CN); BING YU, Shenzhen (CN); JIAN-PING JIN, Shenzhen (CN)

(73) Assignees: FIH (Hong Kong) Limited, Kowloon (HK); SHENZHEN FUTAIHONG PRECISION INDUSTRY CO., LTD., Shenzhen (CN)

(21) Appl. No.: 13/945,097

(22) Filed: Jul. 18, 2013

(30) Foreign Application Priority Data
Feb. 26, 2013 (CN) 2013100592230

(51) Int. Cl. G05B 19/418

(52) U.S. Cl. CPC G05B 19/4189
USPC 700/114

(57) ABSTRACT

A digital control processing device used for processing work pieces includes a base, a rough adjusting module, at least one micro adjusting module, and a processing head module. The rough adjusting module includes a first slider board, a base board slidably mounted on the first slider board along a first direction, a second slider board; and an third slider board slidably mounted on the second slider board along a second direction. The micro adjusting module is mounted on the base board. The processing head module is slidably mounted on the third slider board along a third direction. The processing head module includes at least two processing heads. The rough adjusting module and the micro adjusting module adjust the work pieces to desired positions for the processing heads to process the work pieces.

### BACKGROUND

1. Technical Field

The present disclosure relates to digital control processing devices, especially to a digital control processing device having a plurality of processing heads.

2. Description of Related Art

A Digital control processing device is for processing or cutting complex work pieces automatically. However, the current digital control processing device commonly has one processing head which is used for processing the work piece, thus cannot treating two or more work pieces simultaneously to improve work efficiency.

Therefore, there is room for improvement within the art.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is an isometric view of a digital control processing device in accordance with an exemplary embodiment.

FIG. 2 is a partial exploded view of the digital control processing device of FIG. 1.

FIG. 3 is similar to FIG. 2, but viewed from another aspect.

### DETAILED DESCRIPTION

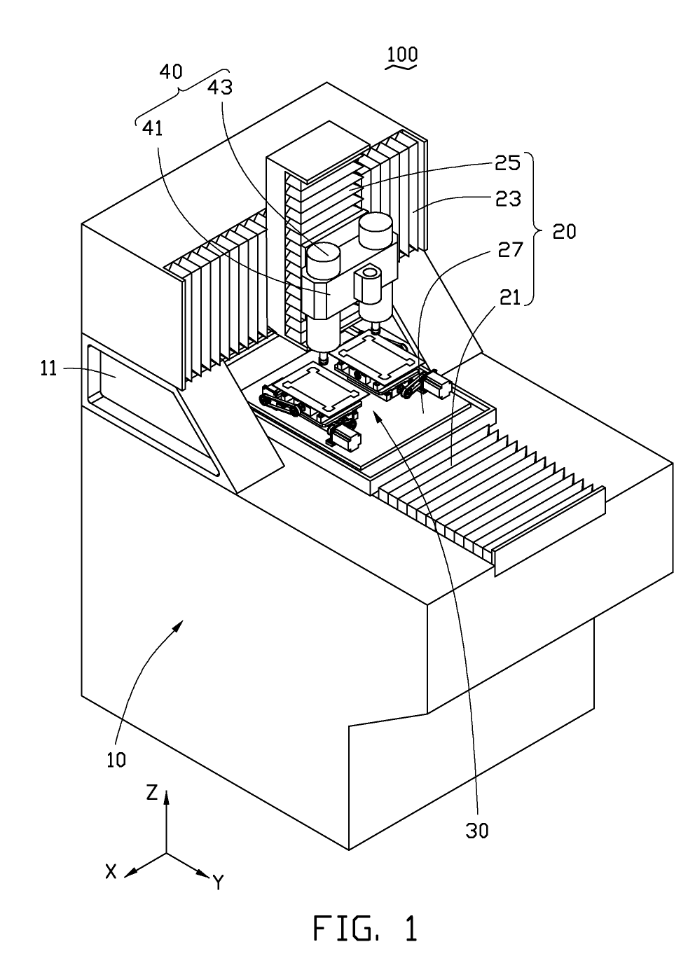

FIG. 1 shows a digital control processing device 100 according to an exemplary embodiment. The digital control processing device 100 includes a base 10, a rough adjusting module 20, a plurality of micro adjusting modules 30, and a processing head module 40. In the exemplary embodiment, there are two micro adjusting modules 30.

The base 10 includes two supporting tables 11. The supporting tables 11 are located on the opposite two sides of a top surface of the base 10.

The rough adjusting module 20 includes a first slider board 21 fastened on the base 10, a second slider board 23 located on the supporting tables 11, a third slider board 25 perpendicularly mounted to the second slider board 23, and a base board 27 positioned on the first slider board 21. The first slider board 21 drives the base board 27 to move along a first direction, namely, the direction of Y-axis of the X-Y-Z coordinate system as shown in FIG. 1. The second slider board 23 drives the third slider board 25 to move along a second direction perpendicular to the first direction, namely, the direction of X-axis of the X-Y-Z coordinate system.

The micro adjusting modules 30 are separately positioned on the base board 27. The processing head module 40 is mounted to the third slider board 25 along the direction of Z-axis of the X-Y-Z coordinate system. The micro adjusting modules 30 can move along with the first slider board 21 to change or adjust the location of the micro adjusting modules 30 on the base 10. The processing head module 40 can move along with the third slider board 25 and the second slider board 23 to change or adjust the location of the processing head module 40 relative to the micro adjusting modules 30.

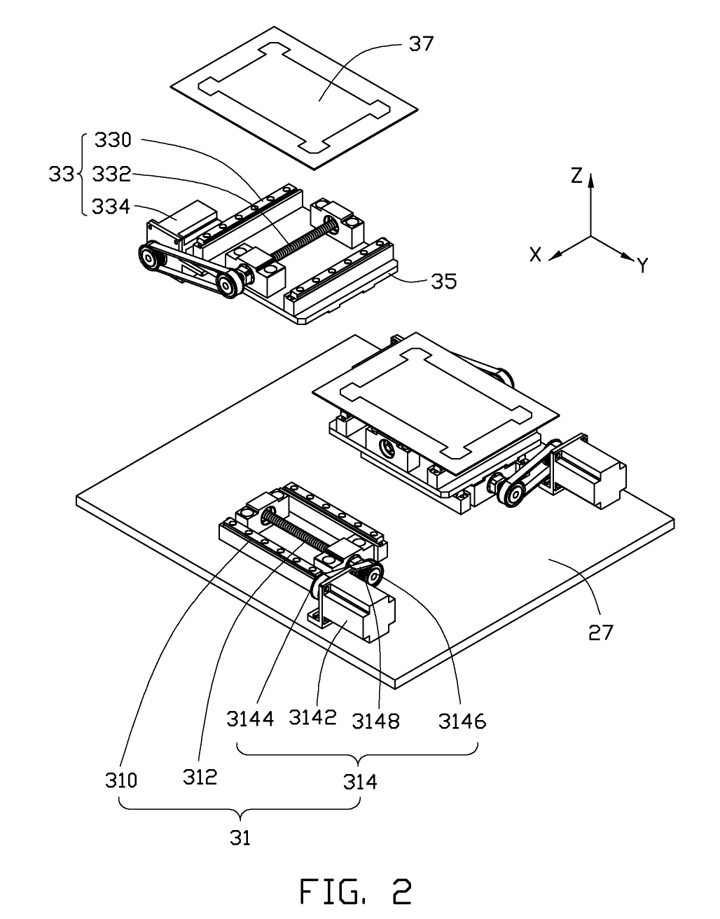

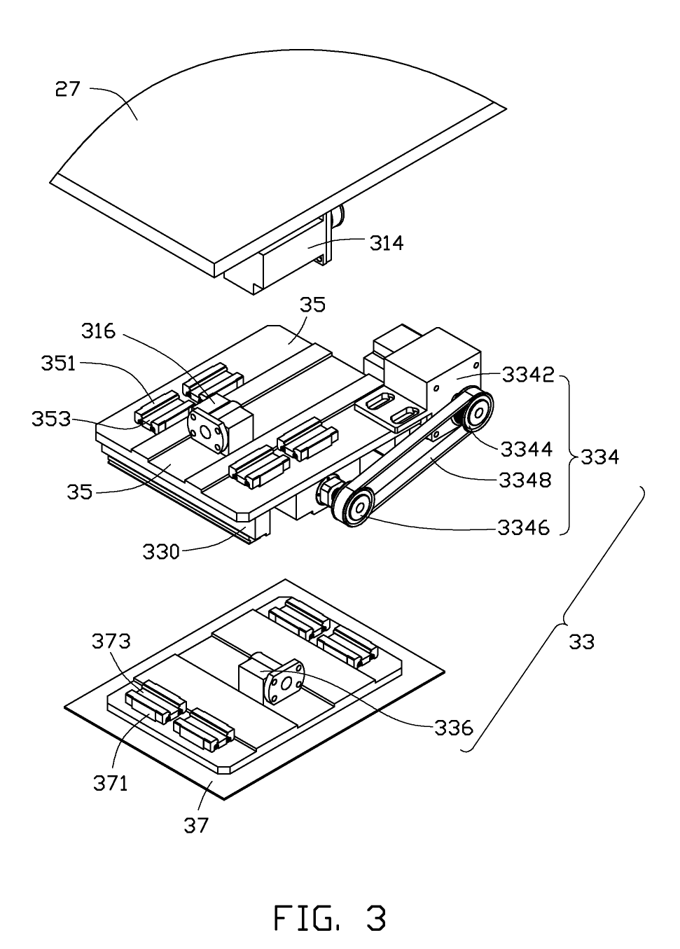

FIGS. 2 and 3 show that each micro adjusting module 30 includes a first adjusting assembly 31, a second adjusting assembly 33, a sliding plate 35, and a worktable 37.

The first adjusting assembly 31 includes two first sliding rails 310 positioned on the base board 27 in parallel along the direction of Y-axis of the X-Y-Z coordinate system, a first threaded rod 312 parallel to and positioned between the first sliding rails 310, a first driver 314 for driving the threaded rod 312 to rotate, and a linking block 316 slidably connected to the first threaded rod 312.

The first driver 314 includes a first motor 3142, a first driving gear 3144, a first driven gear 3146, and a first transmission belt 3148 surrounding on and connecting the two gears. The first driven gear 3146 is mounted on one end of the first threaded rod 312. The first motor 3142 drives the first driving gear 3144 to rotate, allowing the first transmission belt 3148 to drive the first driven gear 3146 to rotate, and the first driven gear 3146 further drives the first threaded rod 312 to rotate. Since the first linking block 316 is slidably connected to the first threaded rod 312, the first linking block 316 is driven by the rotated threaded rod 312 to move along the direction of Y-axis of the X-Y-Z coordinate system. The sliding plate 35 has two pairs of first sliding blocks 351 (see FIG. 3) at the two sides of the sliding plate 35. Each first sliding block 351 defines a first sliding groove 353 corresponding to the first sliding rails 310. The first linking block 316 is also fastened to the sliding plate 35, and positioned between the two pairs of first sliding blocks 351. Therefore, the first linking block 316 can drive the sliding plate 35 to move on the first sliding rails 310 along the direction of Y-axis of the X-Y-Z coordinate system.

The second adjusting module 33 includes two second sliding rails 330 positioned on the sliding plate 35 in parallel along the direction of X-axis of the X-Y-Z coordinate system, a second threaded rod 332 parallel to and positioned between the second sliding rails 330, a second driver 334 for driving the second threaded rod 332 to rotate, and a second linking block 336 slidably connected to the second threaded rod 332.

The second driver 334 includes a second motor 3342, a second driving gear 3344, a second driven gear 3346, and a second transmission belt 3348 surrounding on and connecting the two gears. The second driven gear 3346 is mounted on one end of the second threaded rod 332. The second motor 3342 drives the second driving gear 3344 to rotate, allowing the second transmission belt 3348 to drive the second driven gear 3346 to rotate, the second driven gear 3346 further drives the second threaded rod 332 to rotate. Since the second linking block 336 is slidably connected to the second threaded rod 332, the second linking block 336 is driven by the rotated second threaded rod 332 to move along the direction of X-axis of the X-Y-Z coordinate system. Two pairs of second sliding blocks 371 are positioned on the worktable 37 at the two sides of the worktable 37. Each second sliding block 371 defines a second sliding groove 373 corresponding to the second sliding rails 330. The second linking block 336 is also fastened to the worktable 37, and positioned between the two pairs of second sliding blocks 371. Therefore, the second linking block 336 can drive the worktable 37 to move on the second sliding rails 330 along the direction of X-axis of the X-Y-Z coordinate system.

The processing head module 40 includes a headstock 41 slidably connected to the third slider board 25, a plurality of processing heads 43 fastened by the headstock 41, and a charge-coupled device (CCD) (not shown) received in the headstock 41. The headstock 41 moves on the third slider board 25 along the direction of Z-axis of the X-Y-Z coordinate system. In the exemplary embodiment, there are two processing heads 43. Each processing head 43 is mounted with a cutter (not shown) which is used to cut work pieces (not shown) on the worktable 37. The digital control processing device 100 further includes a control center (not shown). When the CCD catches the position parameters of the work pieces and sends the parameters to the control center, the control center controls the rough adjusting module 20 and the micro adjusting module 30 to remove the work pieces to the desired location on the worktable 37.

During assembly of the digital control processing device 100, the second slider board 23 is mounted to the supporting table 11 of the base 10, the first slider board 21 is mounted on the top surface of the base 10, and the third slider board 25 is slidably mounted to the second slider board 23. The base board 27 is slidably mounted to the first slider board 21. The micro adjusting module 30 is mounted on the base board 27. The processing head module 40 is slidably mounted to the third slider board 25.

When using the digital control processing device 100, the work pieces are first positioned on the worktable 37. The first slider board 21, the second slider board 23, and the third slider board 25 respectively move along the direction of Y-axis, X-axis, and Z-axis of the X-Y-Z coordinate system to adjust the positions of the processing head module 40 and the work pieces. Then, the first driver 314 of the micro adjusting module 30 is turned on to drive the first threaded rod 312 to rotate, allowing the first linking block 316 to drive the sliding plate 35 to move on the first sliding rails 310, thereby the position of the work pieces along the direction of Y-axis is precisely adjusted. In the similar way, the second driver 334 drives the second threaded rod 332 to rotate, allowing the second linking block 336 to drive the worktable 37 to move on the second sliding rails 330, thereby the position of the work pieces along the direction of X-axis is precisely adjusted. As such, the work pieces are precisely positioned on the worktable 37 for the processing head 43 to cut.

The exemplary digital control processing device 100 defines a plurality of processing heads 43, thereby can treat a plurality of work pieces simultaneously, and enhance the efficiency. Further, the digital control processing device 100 also defines the rough adjusting module 20 and the micro adjusting module 30, which can precisely adjust the position of the work pieces for processing.

It is believed that the exemplary embodiment and its advantages will be understood from the foregoing description, and it will be apparent that various changes may be made thereto without departing from the spirit and scope of the disclosure or sacrificing all of its advantages, the examples hereinbefore described merely being preferred or exemplary embodiment of the disclosure.

What is claimed is:

1. A digital control processing device used for processing work pieces, the digital control processing device comprising:
a base;
a rough adjusting module comprising:
a first slider board;
a base board slidably mounted on the first slider board along a first direction;
a second slider board; and
an third slider board slidably mounted on the second slider board along a second direction;
at least one micro adjusting module mounted on the base board; and
a processing head module slidably mounted on the third slider board along a third direction, the processing head module comprising at least two processing heads;
the rough adjusting module and the at least one micro adjusting module adjusting the work pieces to desired positions for the processing heads to process the work pieces.

2. The digital control processing device as claimed in claim 1, wherein the work pieces are positioned on the micro adjusting module, each processing head corresponds to a work piece located on the micro adjusting module, each micro adjusting module comprises a first adjusting assembly, a second adjusting assembly connecting the first adjusting assembly, and a worktable for supporting the work pieces.

3. The digital control processing device as claimed in claim 2, wherein each micro adjusting module further comprises a sliding plate, the sliding plate is slidably mounted on the first adjusting assembly, the first adjusting assembly drives the sliding plate to move along the first direction.

4. The digital control processing device as claimed in claim 3, wherein the second adjusting assembly is mounted on the sliding plate, the worktable is slidably mounted on the second adjusting assembly.

5. The digital control processing device as claimed in claim 3, wherein the first adjusting assembly comprises two first sliding rails mounted on the base board in parallel, a first threaded rod parallel to and positioned between the first sliding rails, a first driver for driving the threaded rod to rotate, and a linking block slidably connected to the first threaded rod, the sliding plate is fastened on the linking block, the first threaded rod rotates to make the first linking block to move on the first sliding rails, the first linking block drives the sliding plate to move along the first direction.

6. The digital control processing device as claimed in claim 5, wherein the second adjusting module comprises two second sliding rails positioned on the sliding plate in parallel, a second threaded rod parallel to and positioned between the second sliding rails, a second driver for driving the second threaded rod to rotate, and a second linking block slidably connected to the second threaded rod, the worktable is fastened on the second linking block, the second threaded rod rotates to make the second linking block move on the second sliding rails, the second linking block drives the worktable to move along the second direction.

7. The digital control processing device as claimed in claim 5, wherein the first driver comprises a first motor, a first driving gear, a first driven gear, and a first transmission belt surrounding on and connecting the two gears, the first driven gear is mounted on one end of the first threaded rod, the first motor drives the first driving gear and the first driven gear to rotate, allowing the first threaded rod to rotate to drive the first linking block to move along the first direction.

8. The digital control processing device as claimed in claim 6, wherein the second driver comprises a second motor, a second driving gear, a second driven gear, and a second transmission belt surrounding on and connecting the two gears, the second driven gear is mounted on one end of the second threaded rod, the second motor drives the second driving gear and the second driven gear to rotate, allowing the second threaded rod to rotate to drive the second linking block to move along the second direction.

9. The digital control processing device as claimed in claim 1, wherein the processing head module further comprises a headstock slidably connected to the third slider board, the processing heads are fastened by the headstock.

10. The digital control processing device as claimed in claim 1, wherein the first direction, the second direction, and the third direction are perpendicular to each other.

11. The digital control processing device as claimed in claim 5, wherein the sliding plate comprises two pairs of first sliding blocks at the two sides of the sliding plate, each first sliding block defines a first sliding groove corresponding to the first sliding rails, the first linking block is positioned between the two pairs of first sliding blocks, the first linking block drives the sliding plate to move on the first sliding rails.

12. The digital control processing device as claimed in claim 6, wherein the worktable comprises two pairs of second sliding blocks positioned at the two sides of the worktable, each second sliding block defines a second sliding groove corresponding to the second sliding rails, the second linking block is positioned between the two pairs of second sliding blocks, the second linking block drives the worktable to move on the second sliding rails.
